(19) United States
(12) Patent Application Publication
(10) Pub. No.: US 2011/0140839 A1
(43) Pub. Date: Jun. 16, 2011

(54) METHOD AND SYSTEM FOR DISABLING PASSIVE ENTRY KEY LOCATED INSIDE A VEHICLE

(75) Inventors: Jason D. DiSalvo, Columbus, OH (US); Hideaki Arai, Powell, OH (US); Takayuki Furui, Utsunomiya (JP); John Sgueglia, Columbus, OH (US); Brian K. Lickfelt, Powell, OH (US)

(73) Assignee: HONDA MOTOR CO., LTD., Tokyo (JP)

(21) Appl. No.: 12/636,236

(22) Filed: Dec. 11, 2009

(51) Int. Cl. G06F 7/04

(52) U.S. Cl. 340/5.61

(57) ABSTRACT

A method for disabling a passive entry key includes receiving a search request into an electronic control unit (“ECU”) on a vehicle to search for a passive key inside a vehicle cabin; emitting a search signal via an antenna in communication with the ECU in response to the received search request; receiving a reply signal via the antenna from the passive key inside the vehicle cabin; and recording in a memory in communication with the ECU an identification of the passive key inside the vehicle cabin in response to the received reply signal. In this method for disabling a passive entry key, the search request can be initiated by an operator at an input device. A passive entry key system is also disclosed.

### BACKGROUND

This disclosure relates to keyless entry systems for a vehicle. More particularly, the disclosure relates to a method and system for disabling a passive entry key located inside a vehicle.

Passive entry key systems use radio frequency communication to determine if a passive entry key is inside or near the vehicle to allow activation of certain systems of the vehicle, e.g. door locks and starter motors. Confirming the location of the passive key is often accomplished by blanketing the vehicle cabin with a radio frequency field. The radio frequency field is designed to activate, or “wake up” the passive key. The passive key responds by emitting a radio frequency signal containing a security code. The security code is checked by the passive entry system to confirm if the key is programmed to the particular vehicle to allow activation of the vehicle systems. If a passive key that is programmed to a particular vehicle is lost inside that vehicle, the vehicle systems that are normally controlled by the passive entry system will always or can always function, which can be problematic.

One known system that can disable a passive entry key that is lost inside a vehicle cabin includes a control system arranged in a vehicle and transponders, or passive entry keys, that communicate with the control system. The control system also includes a memory in which data concerning the transponders can be stored. During or directly after an operator leaves the vehicle, a signal exchange occurs between a transponder being carried by the operator of the vehicle and the control system by way of switches associated with the control system, either automatically or as initiated by the operator, for example by actuating a door handle. The control system generates a locking command for each of the transponders authorized for the vehicle. The control system then transmits a check signal, via an antenna, into the interior of the vehicle, which causes any transponder located in the vehicle to emit a reply signal. If a transponder is located in the vehicle interior, this transponder replies by sending back a reply signal that uniquely characterizes that particular transponder. From the reply signals received from each transponder left inside the vehicle, the control system identifies each transponder left in the interior of the vehicle and flags each transponder left in the vehicle by way of a corresponding entry into the memory. Each transponder that is outside the vehicle interior is not flagged. A vehicle monitoring system is then switched to an active mode and until the vehicle monitoring system is deactivated, the vehicle monitoring system monitors the vehicle interior for break-in attempts. If an attempted break-in is signaled, the control system checks whether the transponder left in the vehicle interior is flagged in the memory as being present in the vehicle. If so, the control system inhibits each flagged transponder. Since the transponder that is outside the vehicle interior is not flagged, it remains uninhibited. To reactivate a transponder that was left inside the vehicle according to this known system, an unlocking command generated by a valid transponder must be received by the control system. Other known systems and methods for disabling a passive entry key that has been left inside a vehicle also disable or enable the passive entry key based upon whether a vehicle door is in a locked or unlocked state.

Passive entry keys, or transponders, that are automatically flagged so as to be inhibited from operating vehicle systems may not provide adequate operator discretion as to whether to activate or deactivate the passive entry key. Moreover, automatic reactivation of a passive entry key that was left inside a vehicle based upon receiving an unlock signal from a valid passive entry key could result in problems with the most recently reactivated passive entry key being taken unbeknownst to the vehicle owner and used to gain access to the vehicle systems without the knowledge of the vehicle owner.

### SUMMARY

A method for disabling a passive entry key that can overcome at least some of the aforementioned shortcomings includes receiving a search request into an electronic control unit (“ECU”) on a vehicle to search for a passive key inside a vehicle cabin; emitting a search signal via an antenna in communication with the ECU in response to the received search request; receiving a reply signal via the antenna from the passive key inside the vehicle cabin; and recording in a memory in communication with the ECU an identification of the passive key inside the vehicle cabin in response to the received reply signal. In this method for disabling a passive entry key, the search request can be initiated by an operator at an input device. The input device can be mounted inside the vehicle cabin or associated with a diagnostic system tool configured to detect problems related with the vehicle.

A passive entry key system that can overcome at least some of the aforementioned shortcomings includes a display mounted in the vehicle cabin, an input device mounted in the vehicle cabin, an electronic control unit (“ECU”) on the vehicle in electrical communication the display and the input device, a transmitter in electrical communication with the ECU, a receiver in electrical communication with the ECU, and a memory in electrical communication with the ECU. The ECU controls the presentation of a query on the display and receives input from the input device in response to the query. The query requests whether to initiate a search for a passive key inside a vehicle cabin. The transmitter is configured to transmit a search signal to identify the passive key located in the vehicle cabin. The receiver is configured to receive a reply signal from the passive key located in the vehicle cabin. The memory is configured to store a record associated with the passive key located in the vehicle cabin that sent a reply signal to the receiver.

Another example of a passive entry key system that can overcome at least some of the aforementioned shortcomings includes a diagnostic system tool configured to detect problems and maintenance issues associated with the vehicle, an electronic control unit (“ECU”) on the vehicle in electrical communication with the diagnostic system tool, a transmitter in electrical communication with the ECU, a receiver in electrical communication with the ECU, and a memory in electrical communication with the ECU. The diagnostic system tool includes a display and an input device. The ECU receives input from the input device in response to a query. The query requests whether to initiate a search for a passive key inside a vehicle cabin. The transmitter is configured to transmit a search signal to identify the passive key located in the vehicle cabin. The receiver is configured to receive a reply signal from the passive key located in the vehicle cabin. The memory is configured to store a record associated with the passive key located in the vehicle cabin that sent a reply signal to the receiver

### BRIEF DESCRIPTION OF THE DRAWINGS

FIG. 1 is a schematic depiction of a vehicle including a passive entry key system.

FIG. 2 depicts an interior vehicle cabin of the vehicle depicted in FIG. 1 including a multi-information display (“MID”) and an input device each mounted in the vehicle cabin.

FIG. 3 is similar to FIG. 2; however, depicting another query presented on the display.

FIG. 4 is a flow diagram depicting a method for disabling a passive entry key located inside the vehicle cabin.

### DETAILED DESCRIPTION

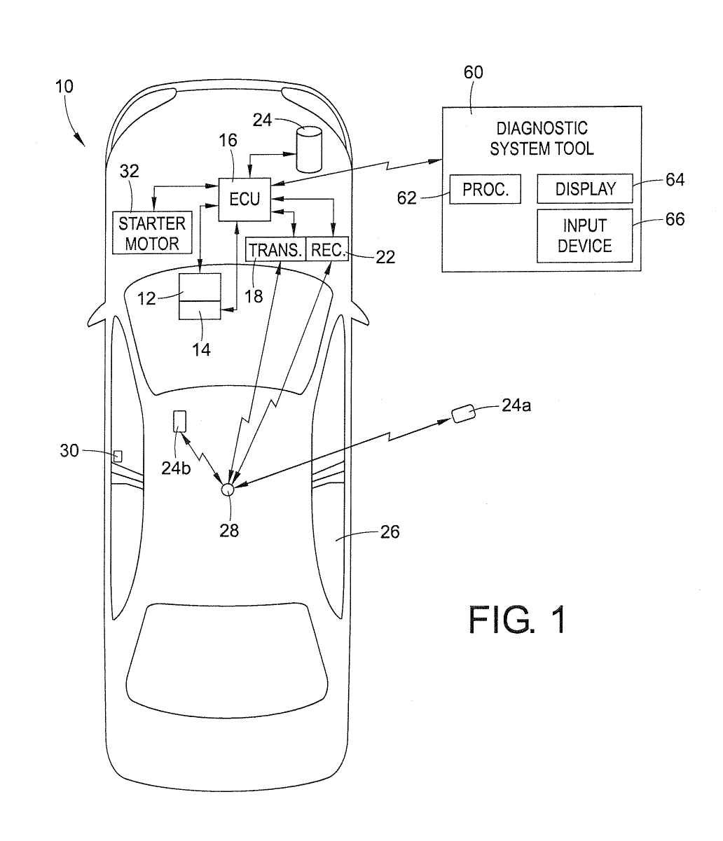

FIG. 1 depicts a vehicle 10 including a passive entry key system. The passive entry key system can include a display 12, an input device 14, an electronic control unit (“ECU”) 16, a transmitter 18, a receiver 22, and a memory 24. A passive key, which in the embodiment illustrated in FIG. 1 includes a first passive key 24a located outside a vehicle cabin 26 and a second passive key 24b located inside the vehicle cabin 26, communicates with the ECU 16 via an the antenna 28, which is in electrical communication with the ECU 16 via the transmitter 18 and the receiver 22. The passive keys 24a, 24b use radio frequency communication to allow the activation of vehicle systems such as door (and trunk) locks 30 (only one lock is shown in FIG. 1 for simplicity) and a starter motor 32. Generally, a radio frequency field, via the transmitter 18 and the antenna 28 is sent out. This field is designed to activate, or “wake up” the passive keys 24a, 24b. The passive keys 24a, 24b respond by emitting a radio frequency signal containing a security code. This security code is received through the antenna 28 and the receiver 22 and is checked by the ECU 16 to confirm if the passive key is programmed to the particular vehicle 10 to allow activation of the vehicle systems such as the door (or trunk) locks 30 and the starter motor 32.

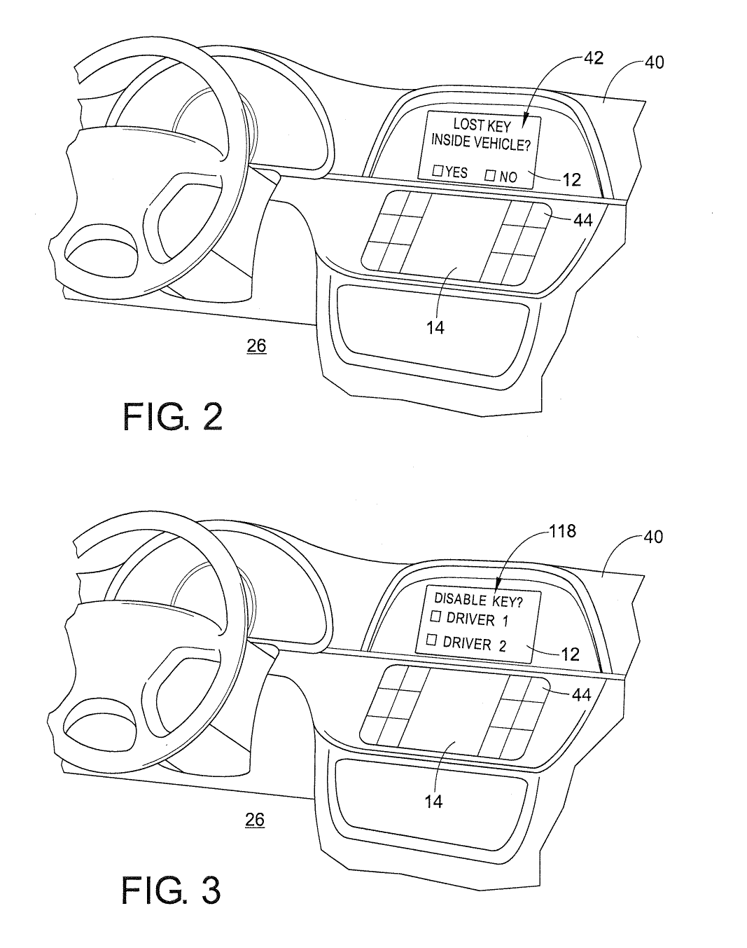

With reference to FIG. 2, the display 12 that is part of the passive entry key system can be a multi-information display (“MID”) found in a dashboard 40 in the vehicle cabin 26. The MID 12 can be an LCD/LED display that can present text and images to an operator of the vehicle 10 (FIG. 1). The ECU 16 (FIG. 1) on the vehicle 10 is in electrical communication with the MID 12 and controls the presentation of text and images on the MID. The MID 12 can display such information as the exterior temperature, the average fuel consumption, a current miles per gallon, as well as other information relevant to the operation of the vehicle. With particular regard to the passive entry key system, the ECU 16 (FIG. 1) controls the presentation of a query 42 on the MID 12. The query 42 shown in FIG. 2 requests an input from the operator of the vehicle 10 to initiate a search for a passive key, e.g. the passive key 24b (FIG. 1), inside the vehicle cabin 26. For example and as shown in FIG. 2, the query 42 presented could display on the MID 12 “Lost Key Inside Vehicle?” and allow the operator of the vehicle to input “yes” or “no.”

With continued reference to FIG. 2, the input device 14 can also be located in the vehicle cabin 26 and is shown mounted to the dashboard 40 below the MID 12. The ECU 16 (FIG. 1) on the vehicle 10 is also in electrical communication with the input device 14. In the embodiment illustrated in FIG. 2, the input device 14 includes a plurality of push buttons 44 that operate switches (not visible) that are in electrical communication with the ECU 16 (FIG. 1). Alternatively, the input device 14 can include at least one of a knob, a trackball, a touch pad, and a touch screen. For example, the MID 12 could be a touch pad and/or a touch screen, which would allow the operator of the vehicle 10 to touch a location directly on the MID to input commands to be received by the ECU 16 (FIG. 1). The ECU 16 can receive input from the input device 14 in response to queries, such as the query 42 depicted in FIG. 2, or the query 42 requests whether to initiate a search for a passive key, for example the passive key 24b (FIG. 1), inside the vehicle cabin 26.

With reference back to FIG. 1, the transmitter 18 is in electrical communication with the ECU 16 and is configured to transmit a search signal via the antenna 28 (a plurality of antennae can be provided). The transmitter 18 can be a component of a transceiver. The search signal is to identify the passive key(s) 24b located in the vehicle cabin 26. The transmitter 18 can also transmit other signals via the antenna 28 to allow for the operation of other vehicle systems.

The receiver 22 is also in electrical communication with the ECU 16. The receiver 22 can be a component of a transceiver. The receiver 22 is configured to receive a reply signal via the antenna 28 from the passive key(s) 24b located in the vehicle cabin 26. The receiver 22 can also receive other signals from the passive keys 24a, 24b to allow for the operation of other vehicle systems, e.g. operation of the door locks 30 and the starter motor 32.

The memory 24 is also in electrical communication with ECU 16. The memory 24 is provided for storing a record associated with the passive key(s) 24b located in the vehicle cabin 26 that sent a reply signal to the receiver. The memory 24 can also store other information.

The passive keys 24a and 24b in the illustrated embodiment can be a card-type portable transceiver configured for a vehicle operator to carry in a pocket or bag. Each passive key 24a, 24b can include a control unit, a low frequency receiver, a radio frequency transmitter, and a radio frequency receiver, similar to known passive keys, accordingly further description of the passive keys is not provided.

With continued reference to FIG. 1, the passive key entry system can also include a diagnostic system tool 60 configured to detect problems and maintenance issues associated with the vehicle. For example, the diagnostic system tool 60 could be similar to an HDS tablet, an HDS Pocket Tester or a computer running appropriate HDS software that are each available from American Honda Motor Co., Inc. Each of the HDS tablet, the HDS Pocket Tester and the computer running appropriate HDS software would be updated, however, to allow for the commands that will be described below to be communicated to the ECU 16. The diagnostic system tool 60 can communicate with the ECU 16 for disabling a passive entry key, e.g. the passive key 24b, located inside the vehicle 10. The diagnostic system tool 60 can include a processor 62 capable of running software to allow for communication between the diagnostic system tool 60 and the ECU 16. The diagnostic system tool 60 can also include a display 64 that can be an LCD/LED display that allows for the display of information to be read by an operator of the diagnostic system tool. The diagnostic system tool 60 can also include an input device 66 configured to allow an operator of the diagnostic system tool to input commands into the diagnostic system tool that can be performed by the ECU 16. Further description of these commands will be provided below with reference to a method for disabling a passive entry key, e.g. the passive entry key 24b depicted in FIG. 1, located inside a vehicle 10.

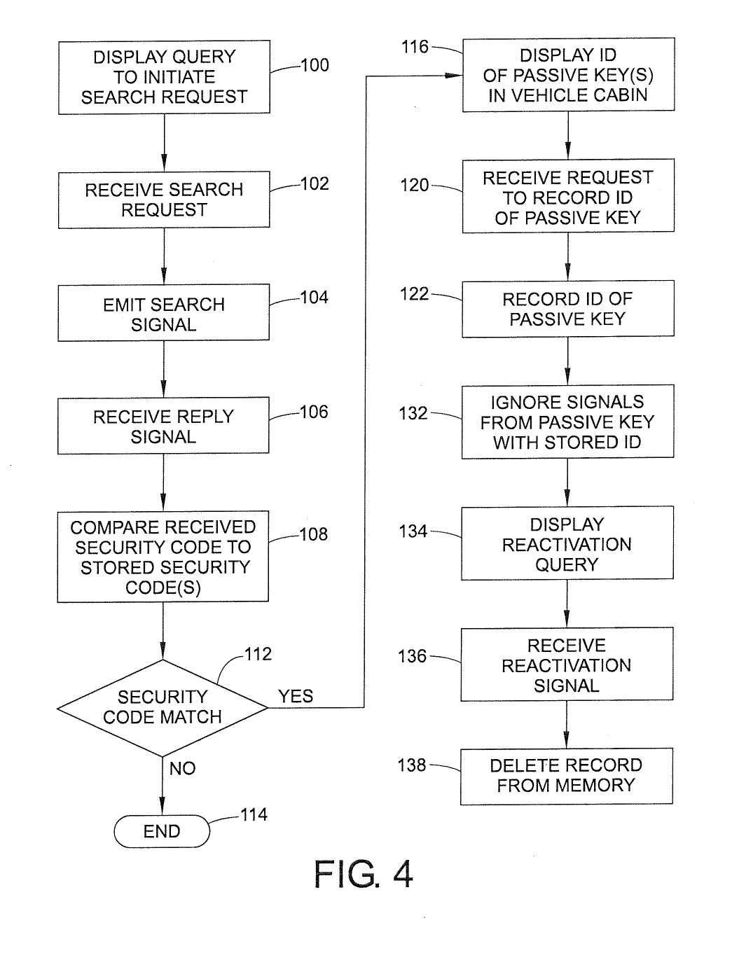

A method for disabling a passive entry key will be described with reference to FIG. 4; however, the order in which the steps of the method are practiced can deviate from the order in which they are depicted in FIG. 4. At 100, the method includes displaying a query, e.g. the query 42 depicted in FIG. 2, on the display 12 where the query requests a command from the operator to initiate a search request. A query similar to the query 42 depicted in FIG. 2 could also be displayed on the display 64 of the diagnostic tool 60 when the diagnostic tool is in electrical communication with the ECU 16 of the vehicle 10.

The method for disabling a passive entry key, e.g. the passive entry key 24b (FIG. 1) located inside the vehicle 10 (FIG. 1) can also include, at 102, receiving a search request into the ECU 16 to search for the passive key inside the vehicle cabin 26 (FIG. 1). For example, with reference to FIG. 2 an operator of the vehicle 10 could select one of the buttons 44 on the input device 14 in response to the query 42 displayed on the display 12. If the operator presses a button 44 associated with “yes” displayed on the MID 12, for example, in response to the query 42, the search request can be received by the ECU 16 (FIG. 1), which is in electrical communication with the input device 14. Also, an operator of the diagnostic system tool 60 could also initiate a search request, which is received by the ECU 16, by inputting a command into the input device 66 of the diagnostic tool in response to a query, similar to the query 42 shown in FIG. 2, displayed on the display 64 of the diagnostic system tool. Accordingly, the search request can be initiated by an operator at an input device, e.g. the input device 14 or the input device 66. As discussed above, the input device 14 is mounted inside the vehicle cabin 26 while the input device 66 is associated with the diagnostic tool 60. More particular to the embodiment depicted in the figures, receiving the search request can further include the search request being initiated by the operator in response to a query, e.g. the query 42, that is displayed on an MID 12 located in the vehicle cabin 26. Alternatively, receiving the search request can further include the search request being initiated by the operator of the diagnostic system tool 60 in response to a query, similar to the query 42 shown in FIG. 2, that is displayed on the display 64 associated with the diagnostic system tool 60.

With reference back to FIG. 4, at 104, the method for disabling a passive entry key, e.g. the passive entry key 24b (FIG. 1), located inside the vehicle 10 can also include emitting a search signal via the antenna 28 in response to the received search request. The search signal can emanate from the transmitter 18, which is in electrical communication with the ECU 16 via the antenna 28, and blanket the vehicle cabin 26. The antenna 28 and/or the vehicle 10 can be configured to limit the radio frequency field emanating from the antenna 28 to only search for passive entry keys within the vehicle cabin 26, e.g. the passive entry key 24b (FIG. 1). For example, the passive entry key 24a, which is located outside the vehicle cabin 26, would not be located by the search signal emitted from the antenna 28.

The search signal emitted from the antenna 28 “wakes up” the passive keys that are located in the vehicle cabin, e.g. the passive entry key 24b (FIG. 1). The method for disabling a passive entry key, e.g. the passive entry key 24b (FIG. 1), located inside the vehicle 10 can also include, at 106, receiving a reply signal via the antenna 28 from the passive key 24b inside the vehicle cabin 26. Receiving the reply signal can further include receiving a security code from the passive key 24b inside the vehicle cabin 26. Each passive key 24a and 24b can be programmed to include a security code and an identification. The security code for each passive key 24a and 24b is a code that can be recognized by the ECU 16 to allow the holder of the passive key 24a, 24b to activate certain systems, e.g. the door locks 30 and the starter motor 32. For example, a passenger in the vehicle 10 carrying a passive key not assigned to the vehicle 10 would not be able to activate certain systems of the vehicle 10 because the security code for the passive key carried by this passenger would not be recognized by the ECU 16 as being allowed to activate these vehicle system, such as the door locks 30 and the starter motor 32. Accordingly, the method for disabling a passive entry key, e.g. the passive entry key 24b (FIG. 1), located inside the vehicle 10 could further include, at 108, comparing the received security code to at least one stored security code, which could be stored in the memory 24. At 112, if the received security code does not match at least one of the stored security codes then the method for disabling a passive entry key located inside the vehicle ends at 114. The passive entry key that sent the security code that does not match at least one of the stored security codes would not be disabled.

At 116, the method for disabling a passive entry key, e.g. the passive entry key 24b depicted in FIG. 1, can further include displaying the identification of each passive key inside the vehicle cabin 26 having a security code that matches at least one of the stored security codes. The identification(s) can be displayed on the display, which can be the display 14 mounted in the vehicle cabin 26 or the display 64 associated with the diagnostic system tool 60. In the illustrated embodiment, each passive key 24a and 24b can include a unique identification. For example, the passive key 24a can include an identification such as “Driver 1” and the passive key 24b can include an identification such as “Driver 2.” With reference to FIG. 3, another query 118 can be presented on the display 14 (which could also be displayed on the display 64 associated with the diagnostic system tool 60) that displays the identification of each passive key inside the vehicle cabin 26 (the query 118 in FIG. 3 depicts the passive key 24a that is located outside the vehicle cabin 26 in FIG. 1 has been carried into the vehicle cabin 26).

At 120, the method for disabling a passive entry key, e.g. the passive entry key 24b in FIG. 1, can further include receiving a request from the input device, e.g. the input device 16 found in the vehicle cabin 26 or the input device 66 associated with the diagnostic system tool 60, to record in the memory 22 the identification of at least one of the passive keys, e.g. the passive key 24a or 24b, which is found inside the vehicle cabin 26. With reference to FIG. 3, the operator is prompted with the query 118 on the display 14 (a similar query can be presented on the display 64 associated with the diagnostic system tool 60) requesting the operator to input whether one of the passive keys is to be disabled. The operator can select the passive key that he is unable to find to be disabled.

The method for disabling a passive entry key, e.g. the passive entry key 24b (FIG. 1), located inside the vehicle 10 also includes, at 122, recording in the memory 22, which is in communication with the ECU 16, an identification of the passive key, e.g. the passive key 24b, inside the vehicle cabin 26 in response to the received request to record the identification of the passive key that the operator is unable to find (step 120). Alternatively, recording in the memory 22 an identification of the passive key, e.g. the passive key 24b, inside the vehicle cabin 26 can be in response to a matched security code (step 112) being received, e.g. the operator need not respond to a query to disable a selected passive key (steps 116 and 120 need not be performed). Accordingly, if the received security code from the passive key 24b matches at least one of the stored security codes in the memory 22, at step 112, the method for disabling the passive entry key records in the memory 22 the identification of the passive key at 122. Accordingly, recording in the memory 22 the identification of the passive key 24b inside the vehicle cabin can include recording the identification of the passive key inside the vehicle cabin when the received security code matches at least one of the stored security codes. The identification that is recorded in the memory 22 corresponds to the identification received in reply from passive key located in the vehicle cabin 26, for example the passive key 24b depicted in FIG. 1. With reference to FIG. 1, the identification key 24a, which is located outside the vehicle cabin 26, is not recorded in the memory, and therefore will not be disabled.

The method for disabling a passive entry key, e.g. the passive entry key 24b, can also include, at 132, ignoring signals received from the passive key, e.g. the passive key 24b, inside the vehicle cabin 26 when the identification for this passive key has been recorded in the memory 22 (FIG. 1). In other words, the passive key 24b, which has been lost inside the vehicle cabin 26 and has had its identification stored in the memory 22, is now disabled so that if it is later found this passive key cannot operate any of the vehicle systems, such as the door locks 30 or the starter motor 32. This is advantageous if the passive key that was lost, e.g. the passive key 24b, is found by someone other than the owner of the vehicle 10. This someone other than the owner of the vehicle would not be able to use this previously lost passive key 24b to activate any of the vehicle systems until the passive key is reactivated.

The method for disabling a passive entry key, e.g. the passive entry key 24b in FIG. 2, can further include, at 134, displaying a query (not shown in the FIGS., but similar to the queries 42 and 118 depicted in FIGS. 2 and 3, respectively) on the display, e.g. the display 14 found in the vehicle cabin or the display 64 associated with the diagnostic system tool 60, requesting a command to reactivate at least one of the passive keys inside the vehicle. In other words, once the passive key 24b is located by an owner of the vehicle, or another authorized person, this passive key can be reactivated by the ECU 16 by deleting the identification, at 138 (described in more detail below) from the memory 22 so that the key is no longer flagged for being inoperative. The reactivation of the passive key 24b is not automatic upon receiving a signal other than the reactivation signal generated by an operator inputting a command via the input device, e.g. the input device 14 found in the vehicle cabin 26 or the input device 64 associated with the diagnostic system tool 60. By requiring the operator to reactivate the formerly disabled passive key, the operator has knowledge as to which passive key can be used to operate or activate vehicle systems of the vehicle 10.

The method for disabling a passive entry key, e.g. the passive entry key 24b located inside the vehicle cabin 26, can also include, at 136, receiving a key reactivation signal initiated at the input device, e.g. the input device 16 mounted inside the vehicle cabin 26 or the input device 64 associated with the diagnostic system tool 60. As discussed above, by requiring the operator to reactivate the formerly inoperative passive key, the operator has knowledge as to when the passive key is able to activate vehicle systems, such as the door locks 30 and the starter motor 32.

At 138, the method for disabling a passive entry key, e.g. the passive entry key 24b located inside the vehicle cabin 26, further includes deleting from the memory 22 a record of the identification of the passive key upon receiving a key reactivation signal initiated at the input device, e.g. the input device 14 mounted in the vehicle cabin 26 or the input device 64 associated with the diagnostic system tool 60. With the identification of the passive key deleted from the memory 22, the passive key is then again able to activate vehicle systems, such as the door locks 30 and the starter motor 32. By requiring operator input via a display, as opposed to automatic reactivation via receiving a door unlock signal, the operator of the vehicle has knowledge as to which passive key can activate vehicle systems of the vehicle 10.

A passive entry key system for a vehicle and a method for disabling a passive entry key located inside a vehicle have been described in particularity with regard to the embodiments shown in the figures described above. Modifications and alterations of these embodiments will occur to those skilled in the art upon reading and understanding the preceding detailed description. The invention, however, is not limited to only the embodiments described above. Instead, the invention is defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for disabling a passive entry key located inside a vehicle, the method comprising:
receiving a search request into an electronic control unit (“ECU”) on a vehicle to search for a passive key inside a vehicle cabin of the vehicle, wherein the search request is initiated by an operator at an input device in communication with the ECU, wherein the input device is mounted inside the vehicle cabin or associated with a diagnostic system tool configured to detect problems related with the vehicle;
emitting a search signal via an antenna in communication with the ECU in response to the received search request;
receiving a reply signal via the antenna from the passive key inside the vehicle cabin; and
recording in a memory in communication with the ECU an identification of the passive key inside the vehicle cabin in response to the received reply signal.

2. The method of claim 1, wherein receiving a search request further includes the display being a multi-information display (“MID”) located in the vehicle cabin.

3. The method of claim 1, wherein receiving a search request further includes the display being the display associated with the diagnostic system tool.

4. The method of claim 1, further comprising displaying a query on the display, wherein the query requests an input command to initiate the search request.

5. The method of claim 1, further comprising ignoring signals received from the passive key inside the vehicle cabin when the identification for the passive key has been recorded in the memory.

6. The method 1, wherein receiving a reply signal includes receiving a security code from the passive key inside the vehicle cabin.

7. The method of claim 6, further comprising comparing the received security code to at least one stored security code.

8. The method of claim 7, wherein recording in the memory the identification of the passive key inside the vehicle cabin includes recording the identification of the passive key inside the vehicle cabin when the received security code matches at least one of the stored security codes.

9. The method of claim 1, further comprising displaying the identification of each passive key inside the vehicle cabin on the display.

10. The method of claim 9, further comprising receiving a request from the input device to record in the memory the identification of at least one of the passive keys inside the vehicle cabin.

11. The method of claim 9, further comprising displaying a query on the display requesting a command to deactivate at least one of the passive keys inside the vehicle.

12. The method of claim 1, further comprising:
receiving a key reactivation signal initiated at the display; and
deleting from the memory a record of the identification of the passive key upon receiving the key reactivation signal.

13. The method of claim 12, wherein receiving the key reactivation signal includes the key reactivation signal being initiated at the display mounted inside the vehicle cabin.

14. The method of claim 12, wherein receiving the key reactivation signal includes the key reactivation signal being initiated at the display associated with the diagnostic system tool.

15. A passive entry key system for a vehicle comprising:
a display mounted in the vehicle cabin;
an input device mounted in the vehicle cabin;
an electronic control unit (“ECU”) on the vehicle in electrical communication with the display and the input device, wherein the ECU controls the presentation of a query on the display and receives input from the input device in response to the query, wherein the query requests whether to initiate a search for a passive key inside a vehicle cabin;
a transmitter in electrical communication with the ECU configured to transmit a search signal to identify the passive key located in the vehicle cabin;
a receiver in electrical communication with the ECU configured to receive a reply signal from the passive key located in the vehicle cabin; and
a memory in electrical communication with the ECU for storing a record associated with the passive key located in the vehicle cabin that sent a reply signal to the receiver.

16. The system of claim 15, wherein the display is a multi-information display (“MID”).

17. The system of claim 15, wherein the input device at least one of a push button, a knob, a track ball, a touch pad, and a touch screen.

18. The system of claim 15, wherein the transmitter and the receiver are components of a transceiver.

19. A passive entry key system for a vehicle comprising:
a diagnostic system tool configured to detect problems and maintenance issues associated with the vehicle, the diagnostic system tool including a display and an input device;
an electronic control unit (“ECU”) on the vehicle in electrical communication with the diagnostic system tool, wherein the ECU receives input from the input device in response to a query, wherein the query requests whether to initiate a search for a passive key inside a vehicle cabin;
a transmitter in electrical communication with the ECU configured to transmit a search signal to identify the passive key located in the vehicle cabin;
a receiver in electrical communication with the ECU configured to receive a reply signal from the passive key located in the vehicle cabin; and
a memory in electrical communication with the ECU for storing a record associated with the passive key located in the vehicle cabin that sent a reply signal to the receiver.

20. The system of claim 19, wherein the transmitter and the receiver are components of a transceiver.
